(19) United States
(12) Patent Application Publication
(10) Pub. No.: US 2025/0105329 A1
(43) Pub. Date: Mar. 27, 2025

(54) ULTRA VIOLET (UV) ASSISTED STACKING SYSTEM FOR A BATTERY CELL STACKING MECHANISM

(71) Applicant: GM Global Technology Operations LLC, Detroit, MI (US)

(72) Inventors: Wai Ping Gloria Tam, Troy, MI (US); David F. Titmuss, Commerce Township, MI (US); Aiden Kwak, Clinton Township, MI (US); Alex Carr, Royal Oak, MI (US); Fang Dai, Troy, MI (US)

(21) Appl. No.: 18/472,692

(22) Filed: Sep. 22, 2023

(51) Int. Cl. H01M 10/04; H01M 10/0583

(52) U.S. Cl. CPC H01M 10/0404; H01M 10/0583

(57) ABSTRACT

A battery stack includes an electrically insulative material formed into a series of folds, the series of folds creating a plurality of foil support surfaces. A battery foil is disposed between adjacent ones of the series of folds. An amount of ultra violet (UV) activated adhesive disposed between the adjacent one of the plurality of foil support surfaces. The amount of UV activated adhesive bonding the adjacent ones of the plurality of foil support surfaces one to another to form a consolidated battery stack.

### INTRODUCTION

The subject disclosure relates to the art of battery cell stacking mechanisms and, more particularly, to an ultra violet (UV) assisted stacking system for the battery cell stacking mechanisms.

Manufacturing speed, and product reliability are important factors in battery cell production. Many softly packaged lithium-ion batteries rely on an insulated member positioned between adjacent battery components. Typically, the insulating member takes the form of a continuous sheet of electrically insulative material that is folded over the battery components to form a stack. In one example, the electrically insulative material passes through a mechanism that creates alternating layers. The alternating layers are folded over and pressed against a battery electrode to form, in one example, a “z-fold stack”. Other systems may manipulate the structure to form a “jelly roll stack”.

Once a selected number of electrodes are separated and formed, the stack is removed, secured, and stored for transit. Given the nature of the stack, folds that are not fully secured may allow the electrode to slip or become misaligned. This misalignment may be exacerbated when the stacks are transported. Misalignment of the battery electrodes may have a detrimental effect on battery efficiency. Accordingly, it is desirable to provide a system to secure battery foils between folds of a battery stack.

### SUMMARY

A battery stack in accordance with a non-limiting example, includes an electrically insulative material formed into a series of folds, the series of folds creating a plurality of foil support surfaces. A battery foil is disposed between adjacent ones of the series of folds. An amount of ultra violet (UV) activated adhesive disposed between the adjacent one of the plurality of foil support surfaces. The amount of UV activated adhesive bonding the adjacent ones of the plurality of foil support surfaces one to another to form a consolidated battery stack.

In addition to one or more of the features described herein each of the plurality of foil support surfaces includes a first dimension defining a first axis and a second dimension defining a second axis, the first dimension being smaller than the second dimension.

In addition to one or more of the features described herein the amount of UV activated adhesive is applied to each of the plurality of foil support surfaces along the first axis.

In addition to one or more of the features described herein each of the plurality of foil support surfaces includes a first end and a second end opposite the first end, the second end being spaced from the first end by the second dimension, the amount of UV activated adhesive being applied to each of the plurality of foil support surfaces along the first axis at each of the first end and the second end.

In addition to one or more of the features described herein each of the plurality of foil support surfaces includes a folded edge extending along the second axis, and a pre-folded edge extending along the second axis spaced from the folded edge by the first dimension.

In addition to one or more of the features described herein the amount of UV activated adhesive is applied to the folded edge along the second axis.

In addition to one or more of the features described herein the amount of UV activated adhesive is applied to the pre-folded edge.

In addition to one or more of the features described herein each of the plurality of foil support surfaces includes a foil support area defined by the first dimension and the second dimension, the amount of UV activated adhesive covering the foil support area.

In addition to one or more of the features described herein the amount of UV activated adhesive substantially, entirely covers the foil support area.

A system for stacking and bonding a battery cell, in accordance with a non-limiting example, includes a stack table including a stack surface, a first battery foil supply table arranged on a first side of the stack table, a second battery foil supply table arranged at a second side of the stack table, and a fold arm supporting an electrically insulated sheet feed system and a fold guide. The fold arm being operable to form a series of folds in an electrically insulative sheet creating a plurality of foil support surfaces. A battery foil assembly system operable to position a battery foil from each of the first battery foil supply table and the second battery foil supply table on select ones of the plurality of foil support surfaces with the select ones of the plurality of foil support surfaces including an amount of ultra violet (UV) activated adhesive.

In addition to one or more of the features described herein a source of UV light arranged adjacent to the stack table.

In addition to one or more of the features described herein the source of UV light is fixedly mounted relative to the stack table.

In addition to one or more of the features described herein the source of UV light is mounted to the fold arm.

In addition to one or more of the features described herein the fold arm creates a battery stack with each of the plurality of foil support surfaces includes a first dimension defining a first axis and a second dimension defining a second axis, the first dimension being smaller than the second dimension.

In addition to one or more of the features described herein the amount of UV activated adhesive is applied to each of the plurality of foil support surfaces along the first axis.

In addition to one or more of the features described herein the fold arm forms each of the plurality of foil support surfaces to include a first end and a second end opposite the first end, the second end being spaced from the first end by the second dimension, the amount of UV activated adhesive being applied to each of the plurality of foil support surfaces along the first axis at each of the first end and the second end.

In addition to one or more of the features described herein the fold arm forms each of the plurality of foil support surfaces to include a folded edge extending along the second axis, and a pre-folded edge extending along the second axis spaced from the folded edge by the first dimension.

In addition to one or more of the features described herein the amount of UV activated adhesive is applied to the folded edge along the second axis.

In addition to one or more of the features described herein the amount of UV activated adhesive is applied to the pre-folded edge.

In addition to one or more of the features described herein the fold arm forms each of the plurality of foil support surfaces to include a foil support area defined by the first dimension and the second dimension, the amount of UV activated adhesive covering the foil support area.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a system for z-stacking and bonding a battery cell, in accordance with a non-limiting example;

FIG. 2 is a plan view of a battery cell stack bonded with an ultra violet (UV) activated adhesive, in accordance with a non-limiting example;

FIG. 3 is a plan view of a battery foil support surface including an amount of UV activated adhesive, in accordance with a non-limiting example;

FIG. 4 is a plan view of a battery foil support surface including an amount of UV activated adhesive, in accordance with another non-limiting example;

FIG. 5 depicts a z-fold arm of the system of FIG. 1 including a UV light source, in accordance with a non-limiting example;

FIG. 6 depicts a z-fold arm of the system of FIG. 1 including a UV light source, in accordance with another non-limiting example; and

FIG. 7 is a battery stack formed by the system of FIG. 1 in a UV light box, in accordance with a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

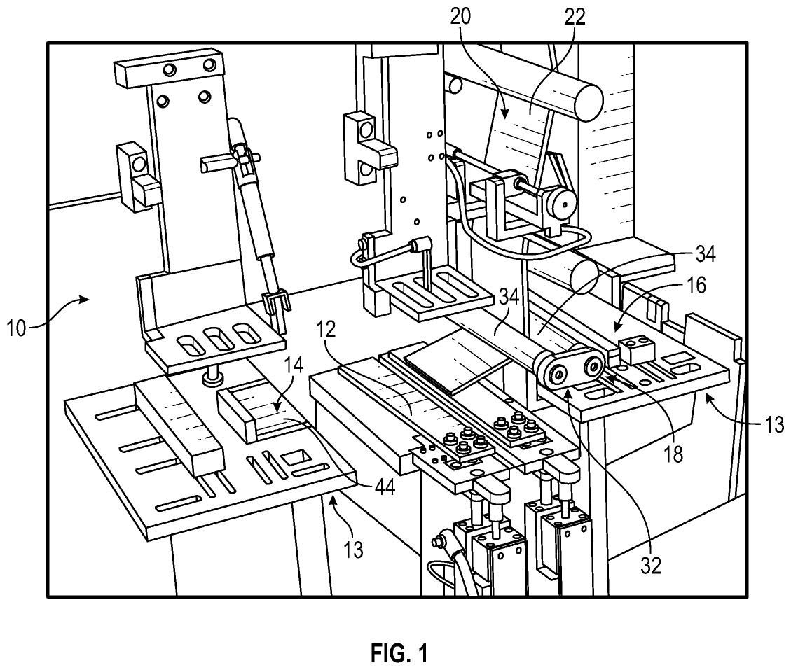

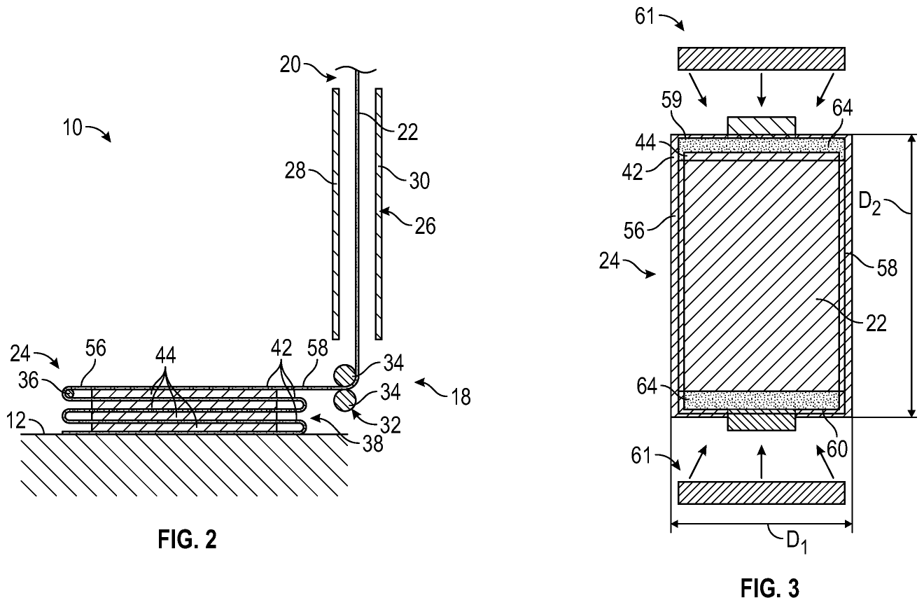

A system for z-stacking and bonding a battery cell, in accordance with a non-limiting example, is indicated generally at 10 in FIG. 1. System 10 includes a stack table 12, and a battery foil assembly system 13 including a first battery foil supply table 14 arranged on one side of stack table 12 and a second battery foil supply table 16 arranged on an opposite side of stack table 12. System 10 includes a z-fold arm 18 having an electrically insulated material feed system 20. Z-fold arm 18 lays an amount of electrically insulated material 22 onto stack table 12, to form a battery stack 24 such as shown in FIG. 2. Z-fold arm 18 includes an ultra violet (UV) light guard 26 including a first guard member 28 and a second guard member 30 that shield the amount of electrically insulated material 22 from UV light as will be detailed more fully herein.

In a non-limiting example shown in FIG. 2, z-fold arm 18 includes a terminal end 32 having a pair of guide rollers 34 that shift electrically insulative material back and forth across stack table 12 to form battery stack 24. Guide rollers 34 pass the amount of electrically insulated material 22 over a selectively shiftable fold guide 36 to create a series of folds 38. In a non-limiting example, each of the series of folds 38 is z-shaped creating a foil support surface 42 upon which is positioned a battery foil 44 by battery foil assembly system 13. A plurality of battery foils 44 and a plurality of battery support surfaces 42 form a consolidated battery stack 46 such as shown in FIG. 7. At this point, it should be understood that the series of folds may take on other geometries.

Reference will now follow to FIG. 3, with continued reference to FIG. 2, in describing one of the plurality of foil support surfaces 42 in a non-limiting example. Foil support surface 42 includes a first dimension D1 defining a first axis and a second dimension D2 defining a second axis that is substantially perpendicular to the first axis. In a non-limiting example, first dimension D1 is smaller than second dimension D2. Foil support surface 42 includes a folded edge 56 that extends along the second axis and a pre-folded edge 58 that extends along the second axis. At this point, it should be understood that the term “folded edge” describes an edge that has been folded over fold guide 36 and the term “pre-folded edge” describes an edge that has not yet been folded. As can be seen in FIG. 3, dimension D2 is defined between a first end 59 and a second end 60 of foil support surface 42.

In a non-limiting example, a curing system, shown in the form of UV lights 61 are fixedly mounted relative to stack table 12 along the first axis. An amount of UV activated adhesive 64 is applied to foil support surface 42. In a non-limiting example, the amount of UV activated adhesive 64 is applied across the first axis at first end 59 and second end 60. Once applied, a z-fold arm 18 is shifted to position a new layer of electrically insulated material 22 over battery foil 44 creating a new foil support surface 42. At this point, UV lights 61 may be illuminated to activate the amount of UV activated adhesive 64 applied to foil support surface 42. In this manner, battery stack 24 includes a plurality of bonded layers that are more stable and less prone to shifting when being stored or transported.

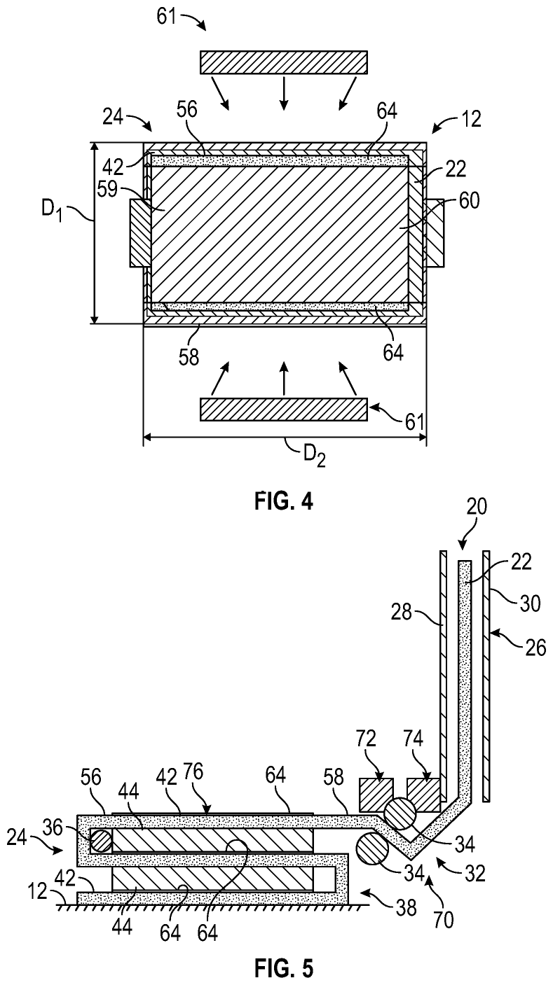

Reference will now follow to FIG. 4 with continued reference to FIG. 2, wherein like reference numbers represent corresponding parts in the respective views, in describing an alternative application of UV activated adhesive 64 in accordance with a non-limiting example. In the non-limiting example shown, the amount of UV activated adhesive 64 is applied along the second axis to pre-folded edge 58. Of course, additional UV activated adhesive 64 may also be applied along the second axis to folded edge 56. UV lights 61 are fixedly mounted relative to stack table 12 along the second axis. In a manner similar to that discussed herein, UV lights 61 are selectively activated to cure the amount of UV activated adhesive 64 in order to bond the series of folds 38 to create consolidated battery stack 46 (FIG. 7).

Reference will now follow to FIG. 5, wherein like reference numbers represent corresponding parts in the respective views, in describing a z-fold arm 70 in accordance with another non-limiting example. Z-fold arm 70 includes a first UV light 72 and a second UV light 74 mounted to terminal end 32 at guide rollers 34. In the non-limiting example shown, foil support surface 42 includes a foil support area 76 defined by the first dimension D1 and the second dimension D2. Foil support area 76 is coated with an amount of UV activated adhesive 64. At this point, it should be apparent that the number and position of UV lights mounted at terminal end 32 may vary and could depend upon the position, geometry, and amount of UV activated adhesive 64 employed.

In a non-limiting example, as z-fold arm 70 traverses across series of folds 38 applying a new layer of electrically insulated material 22 and forming a new foil support surface 42, UV light 74 is illuminated to cure the amount of UV activated adhesive 64 in order to bond the series of folds 38 to create consolidated battery stack 46 in accordance with a non-limiting example.

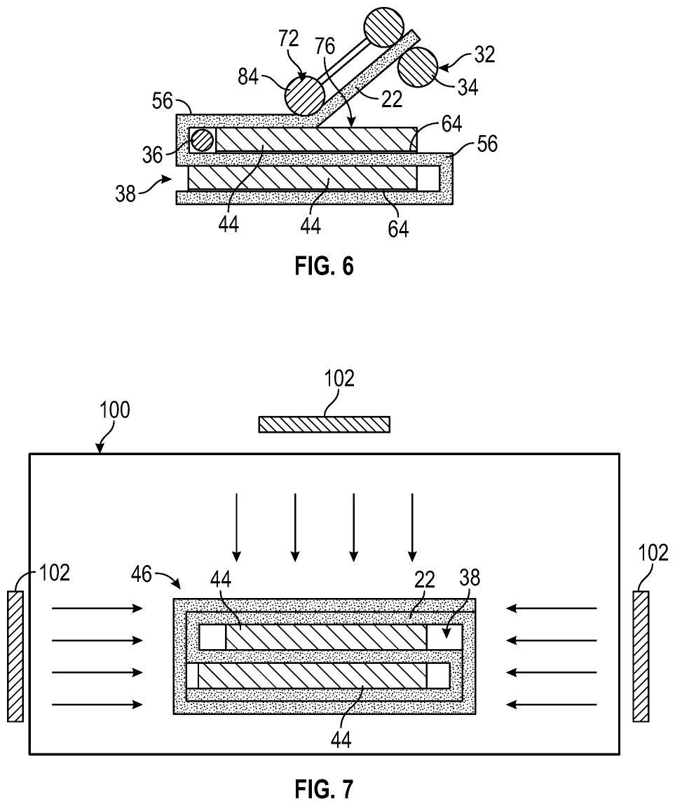

In FIG. 6, UV light 72 is shown in the form of a UV light roller 84 that not only activates the amount of UV activated adhesive 64 but also applies moving pressure to series of folds 38 in order to create a more cohesive bond. In a non-limiting example, shown in FIG. 7, consolidated battery stack 46 is formed by a select number of the series of folds 38 bonded together with battery foil 44. After formation, consolidated battery stack 46 may be deposited into a UV light box 100 where the amount of UV activated adhesive 64 is further cured by a plurality of UV light sources 102 as shown in FIG. 7.

While shown and described in connection with a battery stack formed with z-folds, the non-limiting examples described herein may be used in various other battery manufacturing processes that may employ stacking of components, rolling of components and the like. For example, UV activated adhesive may be incorporated into single sheet stacking processes, winding processes, as well as other processes that embed electrodes between electrically insulating sheet material used to manufacture battery stacks. Further, while shown as being applied to the separator, the UV activated adhesive may be applied to the electrode or the separator and the electrode both. The amount of adhesive applied, the shape of the applied adhesive, and the adhesive application location may vary.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery stack comprising:
an electrically insulative material formed into a series of folds, the series of folds creating a plurality of foil support surfaces;
a battery foil disposed between adjacent ones of the series of folds; and
an amount of ultra violet (UV) activated adhesive disposed between adjacent ones of the plurality of foil support surfaces, the amount of UV activated adhesive bonding the adjacent ones of the plurality of foil support surfaces one to another to form a consolidated battery stack.

2. The battery stack according to claim 1, wherein each of the plurality of foil support surfaces includes a first dimension defining a first axis and a second dimension defining a second axis, the first dimension being smaller than the second dimension.

3. The battery stack according to claim 2, wherein the amount of UV activated adhesive is applied to each of the plurality of foil support surfaces along the first axis.

4. The battery stack according to claim 3, wherein each of the plurality of foil support surfaces includes a first end and a second end opposite the first end, the second end being spaced from the first end by the second dimension, the amount of UV activated adhesive being applied to each of the plurality of foil support surfaces along the first axis at each of the first end and the second end.

5. The battery stack according to claim 2, wherein each of the plurality of foil support surfaces includes a folded edge extending along the second axis, and a pre-folded edge extending along the second axis spaced from the folded edge by the first dimension.

6. The battery stack according to claim 5, wherein the amount of UV activated adhesive is applied to the folded edge along the second axis.

7. The battery stack according to claim 6, wherein the amount of UV activated adhesive is applied to the pre-folded edge.

8. The battery stack according to claim 2, wherein each of the plurality of foil support surfaces includes a foil support area defined by the first dimension and the second dimension, the amount of UV activated adhesive covering the foil support area.

9. The battery stack according to claim 8, wherein the amount of UV activated adhesive substantially, entirely covers the foil support area.

10. A system for stacking and bonding a battery cell comprising:
a stack table including a stack surface;
a first battery foil supply table arranged on a first side of the stack table;
a second battery foil supply table arranged at a second side of the stack table; and
a fold arm supporting an electrically insulated sheet feed system and a fold guide, the fold arm being operable to form a series of folds in an electrically insulative sheet creating a plurality of foil support surfaces; and
a battery foil assembly system operable to position a battery foil from each of the first battery foil supply table and the second battery foil supply table on select ones of the plurality of foil support surfaces,
wherein the select ones of the plurality of foil support surfaces include an amount of ultra violet (UV) activated adhesive.

11. The system according to claim 10, further comprising a source of UV light arranged adjacent to the stack table.

12. The system according to claim 11, wherein the source of UV light is fixedly mounted relative to the stack table.

13. The system according to claim 11, wherein the source of UV light is mounted to the fold arm.

14. The system according to claim 10, wherein the fold arm creates a battery stack with each of the plurality of foil support surfaces includes a first dimension defining a first axis and a second dimension defining a second axis, the first dimension being smaller than the second dimension.

15. The system according to claim 14, wherein the amount of UV activated adhesive is applied to each of the plurality of foil support surfaces along the first axis.

16. The system according to claim 14, wherein the fold arm forms each of the plurality of foil support surfaces to include a first end and a second end opposite the first end, the second end being spaced from the first end by the second dimension, the amount of UV activated adhesive being applied to each of the plurality of foil support surfaces along the first axis at each of the first end and the second end.

17. The system according to claim 14, wherein the fold arm forms each of the plurality of foil support surfaces to include a folded edge extending along the second axis, and a pre-folded edge extending along the second axis spaced from the folded edge by the first dimension.

18. The system according to claim 17, wherein the amount of UV activated adhesive is applied to the folded edge along the second axis.

19. The system according to claim 18, wherein the amount of UV activated adhesive is applied to the pre-folded edge.

20. The system according to claim 11, wherein the fold arm forms each of the plurality of foil support surfaces to include a foil support area defined by the first dimension and the second dimension, the amount of UV activated adhesive covering the foil support area.
